(19) United States
(12) Patent Application Publication
(10) Pub. No.: US 2025/0042336 A1
(43) Pub. Date: Feb. 6, 2025

(54) CAMERA SYSTEM, INSTALLATION METHOD, AND STORAGE MEDIUM

(71) Applicant: CANON KABUSHIKI KAISHA, Tokyo (JP)

(72) Inventor: Minoru OHKOBA, Chiba (JP)

(21) Appl. No.: 18/777,617

(22) Filed: Jul. 19, 2024

(30) Foreign Application Priority Data
Aug. 1, 2023 (JP) 2023-125693

(51) Int. Cl. B60R 1/29; B60R 1/28; B60R 11/00; B60R 11/04; H04N 23/611; H04N 23/67; H04N 23/698

(52) U.S. Cl. CPC B60R 1/29; B60R 1/28; B60R 11/04; H04N 23/611; H04N 23/67; H04N 23/698; B60R 2011/0028

(57) ABSTRACT

To provide a camera system capable of simultaneously imaging a region of interest in a predetermined state by one wide-angle camera, a wide-angle camera disposed in an interior of a vehicle is provided in a camera system, wherein the wide-angle camera is disposed between a driver's seat and a rear seat so that an optical axis is directed downward, and a region of interest during travel of the vehicle and a region of interest while stopped of the vehicle fall within a range of φ/2 to φ with respect to an angle φ, which is a viewing angle of the wide-angle camera.

### BACKGROUND OF THE INVENTION

### Field of the Invention

The present invention relates to an in-vehicle camera system, an installation method, a storage medium, and the like.

### Description of the Related Art

In the related art, a vehicle interior camera that observes a state of a driver or a state of an occupant by observing a vehicle interior during the travel is known. Additionally, a camera that observes a traveling state outside the vehicle during the travel simultaneously with the observation of the interior of the vehicle, and that monitors a person who is outside the vehicle while stopped and harms the vehicle or a person who breaks into the vehicle is known.

Additionally, a technology in which a vehicle interior camera is used for a plurality of purposes is known. For example, Japanese Patent Application Laid-Open No. 2022-102525 discloses a technology in which a recognition image of the interior of a vehicle is captured with high sensitivity while the vehicle is traveling, and a recognition image of the exterior of the vehicle is captured with low sensitivity.

Japanese Patent Application Laid-Open No. 2012-228931 discloses a technology of dividing a captured image into a vehicle interior region and a vehicle exterior region, acquiring the brightness of a portion to be observed, controlling an imaging condition in each region, and recording the image on a drive recorder.

However, the related art as disclosed in Japanese Patent Application Laid-Open No. 2022-102525 disclosed above does not specify the angle of view of the camera and the like, and furthermore, it does not refer to the monitoring of the surroundings while the vehicle is stopped. Therefore, it is not clear how many camera systems should be prepared in order to monitor the surroundings while the vehicle is stopped.

Additionally, in the prior art disclosed in Japanese Patent Application Laid-Open No. 2012-228931, a camera system in which monitoring the entire surroundings of the vehicle exterior is introduced into the field of vision is not designed, and a region of interest in the vehicle interior and a region of interest outside the vehicle interior are separated within the angle of view of the camera. Accordingly, a high resolution is required for each region to enable achieving the purpose. Therefore, an expensive image sensor having a high resolution is required.

### SUMMARY OF THE INVENTION

A camera system of one aspect of the present invention comprising: a wide-angle camera disposed in an interior of a vehicle, wherein the wide-angle camera is disposed between a driver's seat and a rear seat so that an optical axis is directed downward, and a region of interest during travel of the vehicle and a region of interest during a stop of the vehicle fall within a range of φ/2 to φ with respect to an angle φ, which is a viewing angle of the wide-angle camera.

Further features of the present invention will become apparent from the following description of embodiments with reference to the attached drawings.

### BRIEF DESCRIPTION OF THE DRAWINGS

FIGS. 1A and 1B are diagrams for explaining an example of the disposition of a wide-angle camera according to the first embodiment of the present invention.

FIGS. 2A and 2B are diagrams for explaining images captured by a vehicle interior wide-angle camera according to the first embodiment of the present invention.

FIG. 3 is a diagram showing image height characteristics of a fisheye lens having an angle of view from an optical axis of 0 degrees to 90 degrees in an optical system according to the first embodiment.

FIGS. 4A and 4B are diagrams showing an example of a relation between a camera and an object of interest (region of interest) according to the first embodiment.

FIG. 5 is a diagram illustrating an example of a camera disposition and an example of a determination result in the first embodiment.

FIG. 6 is a diagram illustrating an example of camera disposition and an example of a determination result of Comparative Example 1 that is different from the first embodiment.

FIG. 7 is a diagram illustrating an example of Comparative Example 2 in which image height characteristics is different from those of the first embodiment.

FIG. 8 is a flowchart showing an example of an operation condition changing processing during the capture of an image in the third embodiment.

FIGS. 9A and 9B are diagrams for explaining an example of a region of interest in a camera system according to the fifth embodiment.

FIG. 10 is a diagram illustrating an example of relation between a camera and an object of interest according to the fifth embodiment.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

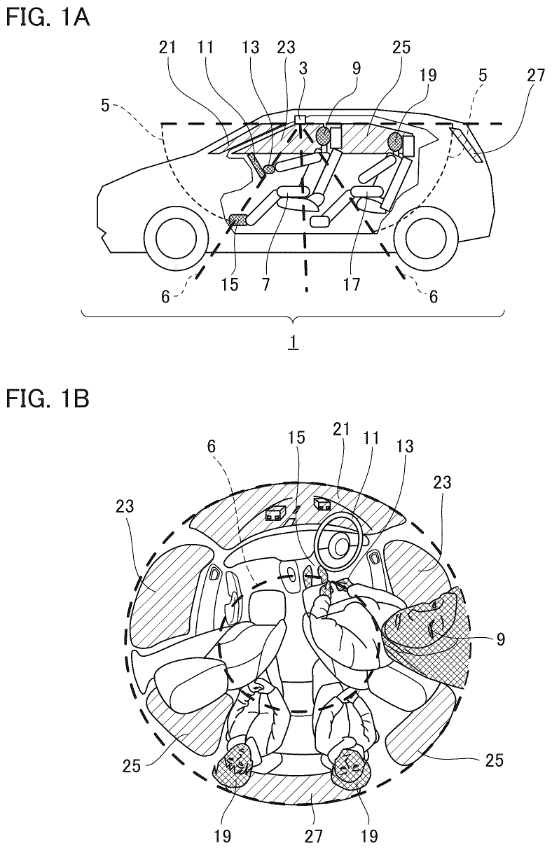

FIGS. 1A and 1B are diagrams for explaining an example of disposition of a wide-angle camera according to the first embodiment of the present invention. FIG. 1A is a longitudinal sectional view of an automobile, and FIG. 1B is a diagram showing an example of an image captured by a camera.

In the drawing, reference numeral 1 denotes an automobile (vehicle) serving as a movable apparatus, reference numeral 3 denotes a wide-angle camera disposed in the interior of the automobile, reference numeral 5 denotes a peripheral visual field region, reference numeral 6 denotes a peripheral viewing angle boundary, reference numeral 7 denotes a driver, reference numeral 9 denotes a driver's head, reference numeral 11 denotes a steering wheel, reference numeral 13 denotes a driver's hand, reference numeral 15 denotes driver's feet, and reference numeral 17 denotes a rear-seat occupant. Additionally, reference numeral 19 denotes a rear seat occupant's head, reference numeral 21 denotes a front window, reference numeral 23 denotes side windows of a driver's seat and a passenger seat, reference numeral 25 denotes side windows of the rear seat, and reference numeral 27 denotes a rear window.

FIG. 1 shows an example in which the automobile 1 is a sedan with two rows of seats, but may be a station wagon or the like. The rear seats may also be arranged in two or three rows. Although, the automobile 1 may also be a micro-bus and the like having more rear seats, it is preferable that the vehicle has two or three rows of seats in order to suitably apply the present embodiment. That is, this is because the rear seat occupant's head 19 can be observed well if the vehicle has up to three rows of seats.

The wide-angle camera 3 is a camera having a viewing angle of 90 degrees or more, and having a wide-angle lens, for example, a fisheye lens. That is, the wide-angle camera 3 of the present embodiment includes a fisheye lens camera. The wide-angle camera 3 has a lens, an image sensor, a digital signal processing unit, a communication unit, and the like.

The lens forms an image of the outside of the camera on a light-receiving surface of the image sensor, and the image sensor converts light information into an analog voltage signal and further into a digital signal to form digital image data. The digital image data are processed by a data signal processing unit, and transmitted to the outside as image data or recorded.

The image data are displayed as an image on a monitor serving as a display unit, and is used for determination by a driver. Furthermore, image recognition processing is performed, and the recognition result is used for automatic driving and driving assistance. Additionally, the image data are used directly in real time. Furthermore, by storing the image data in the storage devices, the image data are used for confirming a hit or escape from a surrounding vehicle during the travel, confirming route obstruction information, confirming a situation of damage such as vehicle break-in while stopped, and the like.

Reference numeral 5 denotes a surrounding visual field region. In a case where the optical axis is set to 0 degrees and an angle from the optical axis to an end point of a field of view (FOV) in which an end portion of an image appears is reflected to φ, the surrounding visual field region 5 is φ/2 to φ. In the case of a fisheye lens of which one side is at 90 degrees from the optical axis, the surrounding visual field region refers to a region of 45 degrees to 90 degrees in a case where the optical axis is at 0 degrees.

Reference numeral 6 denotes a surrounding viewing angle boundary, and a boundary of φ/2 is defined as a surrounding viewing angle boundary. When an image displayed on the image sensor is observed in a state in which distortion correction is not performed, this boundary is indicated by a circle as shown with reference numeral 6 in FIG. 1B. When viewed as a cross-sectional image, the boundary is shown by a broken line in FIG. 1A.

The driver 7 is seated on the right side in FIG. 1B. However, if the vehicle has a steering wheel on the left side, the driver may be seated on the left side.

Reference numeral 9 denotes a driver's head. The position of the driver's head changes depending on the posture of the driver 7. However, in many cases, the driver's head is positioned in front of the headrest, and thus, in the present embodiment, the position of the driver's head in front of the headrest is assumed to be the position of the driver's head 9. Additionally, if there is no headrest, the position of the eyes may be used as the position of the driver's head 9 since the position of the eyes is defined for each vehicle in the model authentication test.

Reference numeral 11 denotes a steering wheel, which has a function of steering the automobile in a forward direction and a backward direction. Although, in FIG. 1B, the steering wheel 11 is disposed on the right side in the vehicle, there is a case in it is disposed on the left side. The steering wheel 11 may be circular or may not be circular. In the present embodiment, even a part of the steering wheel 11 can be observed with high resolution, and thus, information on a steering state can be obtained, and therefore, the steering wheel 11 may be a part of the steering wheel.

Reference numeral 13 denotes a driver's hand, which transmits the driver's determination to the steering wheel during the steering. As in the case of the steering wheel, in the present embodiment, even a part of the driver's hand 13 can be observed with high resolution, so that information on the steering state can be obtained. Therefore, the driver's hand 13 may be a part of the hand. Although, in some cases, the driver wears gloves, and in other cases, the hand cannot be seen completely due to clothes, in such a case, the assumed position of the hand is set as the position of the driver's hand 13.

Reference numeral 15 denotes a driver's foot. The driver's foot is mainly intended to step on the accelerator and the brake in driving, and is an object of the region of interest. Note that, in many cases, the foot 15, which is an actual observation target, is a shoe. Similar to the driver's hand 13, even a part of the driver's foot 15 is treated as the driver's foot 15 this time. Additionally, in a case where the foot cannot be completely seen due to the clothes, the assumed position of the foot is set as the position of the driver's foot 15.

In particular, in the lateral direction of the foot position, the driver can freely move to some extent. However, since the driver is most interested in the operation of the accelerator and the brake, the lateral position of the foot is determined with reference to the line of the center of the body in the lateral direction.

Reference numeral 17 denotes a rear seat occupant. The occupant is an occupant in a seat behind the driver's seat, and, in FIG. 1B, a state is shown in which two rear seat occupants 17 are seated in the rear seat, assuming a general sedan with two rows of seats. However, in the case of a multi-row seat such as a three-row seat, it is assumed that an occupant seated in the multi-row seat behind the driver's seat is a rear seat occupant. Additionally, a person seated in a child seat and a junior seat may be a rear seat occupant.

Reference numeral 19 denotes a rear seat occupant's head. This is the position of the head of the rear seat occupant 17, and similarly to the driver 7, although the head position changes depending on the posture, the head is positioned in front of the headrest for most of the time, so the head positioned in front of the headrest is treated as the rear seat occupant's head 19.

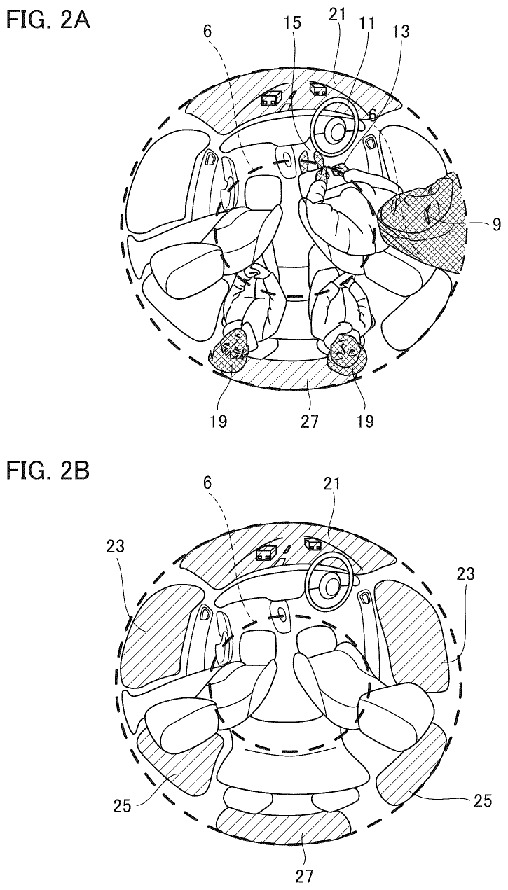

Next, an example of the positional relation between the camera and the region of interest according to the present embodiment will be described with reference to FIG. 2. FIGS. 2A and 2B are diagrams for explaining an image captured by a vehicle interior wide-angle camera according to the first embodiment of the present invention. FIG. 2A is a view of an image of a region of interest during the travel, and FIG. 2B is a view of an image of a region of interest during the parking. Note that, in FIGS. 2A and 2B, the region shown by hatching is a region of interest.

A region shown by hatching in FIG. 2A is a region of interest during the travel, and the region of interest during the travel includes a physical state of a driver, a state of an occupant in a rear seat, and the like. That is, the region of interest during the travel is a region including the head of the person who is in the interior of the vehicle. In particular, since the physical state of the driver is directly related to the safety of driving, a region having a relatively high resolution is assigned so that the facial expression can be recognized to detect drowsiness and the like.

Additionally, in the present embodiment, it is possible to record the presence or absence of an erroneous operation while driving by arranging the steering wheel 11, the hand 13, and the foot 15 so as to be seen as the region of interest. Additionally, it is assumed that the front in the traveling direction of the automobile is also a region of interest during traveling.

Note that it is desirable that the video of the region of interest acquired during the travel is used for automatic driving, calling attention to drowsiness, and the like. Additionally, the user may specify (set) a region of interest by using a GUI while viewing an image.

Specifically, for example, as a region of interest during the travel, at least one of the driver's head 9, the rear seat occupant's head 19, the steering wheel 11, the driver's hand 13, the driver's foot 15, the front window 21, and the like is set as the initial setting. That is, the region of interest during the travel is a region including a foot of the driver. In addition, it is desirable that the user can select and register at least one among these as the region of interest.

A region of interest while stopped assumes a case where there is almost no change in the in-vehicle environment while stopped and a person who will break into the vehicle and the like approach the automobile from the surroundings, as shown by the hatching in FIG. 2B. Therefore, in the present embodiment, it is possible to capture an image of a person who harms the vehicle and monitor the surroundings of the vehicle by making the outside of the windows located in the direction of 360-degree view of the surroundings visible. That is, the region of interest while stopped is a region including the outside of the window of the automobile.

Specifically, the windows are the front window 21, the front seat side windows 23, the rear seat side windows 25, and the rear window 27, and since the outside of the vehicle through each window is set as a region of interest, each glass itself corresponds to the region of interest serving a region of interest from the inside of the vehicle.

However, since there is a pillar (support) portion, the angle does not become completely 360 degrees. However, in many vehicles, the glass region is wider than the pillar, and it is possible to observe the outside of the window in all directions from the inside of the vehicle, and thus, it is possible to sufficiently achieve the functions of capturing images of a person who harms the vehicle and monitoring the surroundings of the vehicle. Therefore, in the present embodiment, the region of the omnidirectional windows is set as the region of interest while stopped.

Additionally, in the camera system according to the present embodiment, it is possible to provide an inexpensive camera system capable of effectively monitoring the inside and outside of the vehicle with one camera by setting the optical characteristics and disposition of the cameras to predetermined conditions.

Specifically, in the present embodiment, in a vehicle in which the height of the interior space in the interior of the vehicle is relatively high, the viewing angle, which is an optical characteristic of the camera, is set to a wide angle of approximately 45 degrees, and the camera is disposed facing downward on the roof of the interior of the vehicle, whereby the above-described regions of interest can be captured simultaneously.

Additionally, in a vehicle in which the height of the interior space in the interior of the vehicle is relatively low, since the positional relation between the roof and the driver's head 9 is close to horizontal, the viewing angle is set to approximately 90 degrees on one side so that an image can be captured substantially horizontally in a case where the optical axis of the camera is directed downward.

Additionally, the object of interest (region of interest) during the travel is mainly a face, the object of interest (region of interest) while stopped is mainly outside the all-around window, and thus, traveling and stopping differ in terms of time. Accordingly, the face during the travel and the window while stopped in the image captured by the camera are arranged so as to be substantially the same region. Thereby, the number of pixels of the image sensor can be efficiently allocated.

Additionally, it is assumed that the position of the camera satisfying such a condition is between the driver's seat and the passenger seat in the lateral direction of the vehicle, and between the driver's seat and the rear seat in the longitudinal direction of the vehicle, in particular, a position where the driver's head 9 and the rear seat occupant's head 19 are simultaneously reflected. Additionally, at this time, it is desirable that the front window 21, the front seat side windows 23, the rear seat side windows 25, and the rear window 27 are arranged at positions where they are simultaneously reflected.

Additionally, in the present embodiment, as shown in FIGS. 2A and 2B, in a fish-eye camera having a viewing angle of about 90 degrees on one side, the camera is disposed so that the region of interest falls within the range of about 45 degrees to about 90 degrees.

That is, in the present embodiment, the region of interest when the automobile is traveling and the region of interest when the automobile is stopped are arranged so as to fall within the range of φ/2 to φ with respect to the angle φ, which is the viewing angle of the wide-angle camera. Additionally, the present embodiment is configured so that the resolution in the range of φ/2 to φ is higher than the resolution in the other ranges.

Therefore, objects in which the importance as information is relatively low are concentrated in the central portion. Additionally, since a distance from the roof to the object is relatively short in the central portion, the occupied angular range is narrow, and it is not necessary to increase the pixel density. In the present embodiment, it is not necessary to use an image sensor having a high resolution by using a camera having the optical characteristics as described above.

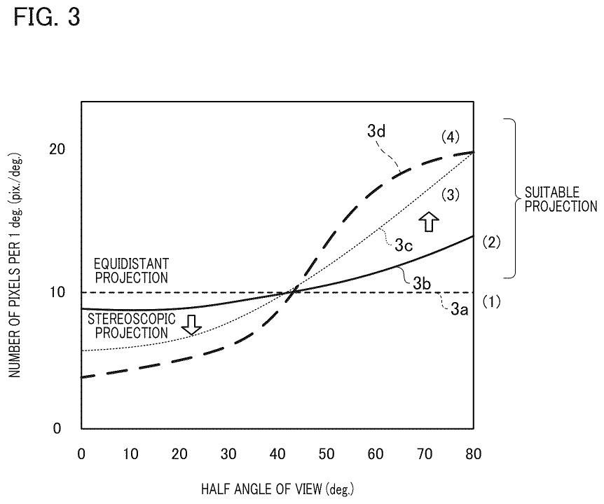

A specific example of the image height characteristic of the camera in the present embodiment will be explained with reference to FIG. 3. FIG. 3 is a diagram showing image height characteristics of a fisheye lens having an angle of view from an optical axis of 0 degrees to 90 degrees in the optical system according to the first embodiment.

In FIG. 3, 3a is an example of image height characteristic in the case of equidistant projection, and is characterized in that the number of pixels per 1 deg. (1 degree) is constant. That is, when the coordinate y on the image sensor, the viewing angle (angle from the optical axis) φ, and k are constants, they can be expressed by y=k·φ.

3b is an example of an image height characteristic in the case of stereographic projection, and the pixel density of the periphery is slightly higher than that of the center, and it can be expressed by y=2k·tan φ. Additionally, 3c and 3d indicate examples in a case where the number of pixels per 1 deg. of the periphery is larger than the stereographic projection of 3b.

In the present embodiment, a camera having relatively high pixel densities at 45 degrees to 90 degrees is obtained by adopting a lens having an image height characteristics of 3b, 3c, and 3d. Therefore, it is not necessary to select an image sensor having an excessively high number of pixels, and the region of interest can be imaged at a high-resolution suitable for the purpose.

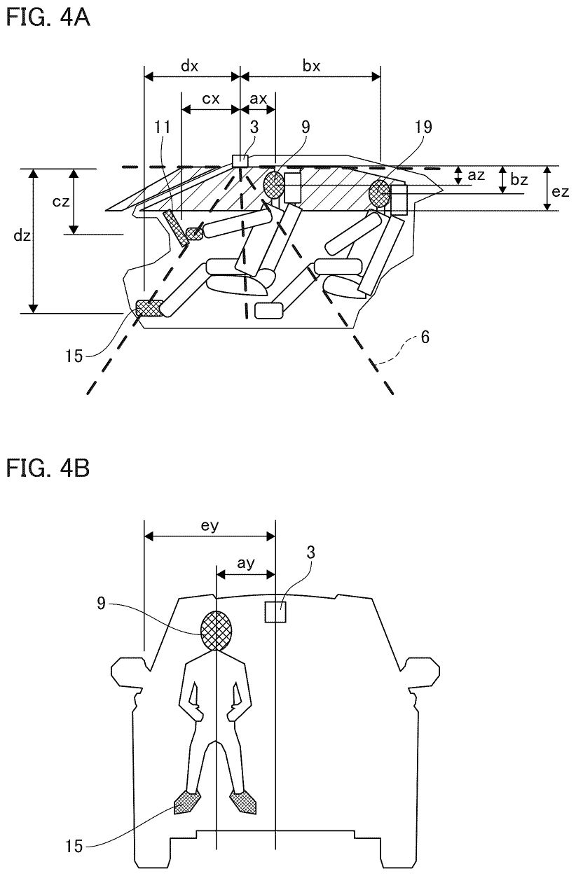

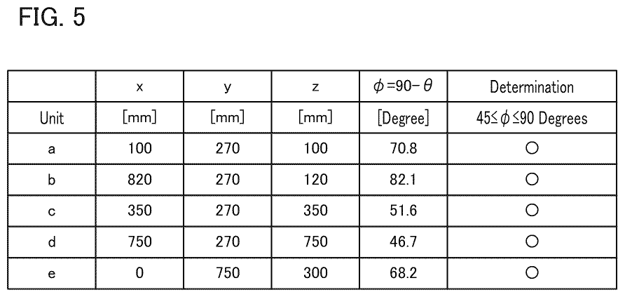

Next, a camera system according to the first embodiment of the present invention will be explained with reference to FIG. 3, FIGS. 4A, 4B, and FIG. 5. FIGS. 4A and 4B are diagrams showing an example of the relation between a camera and an object of interest (region of interest) according to the first embodiment. In FIG. 4, “ax” represents a distance between the wide-angle camera 3 and the driver's head 9 in the front-rear direction, “ay” represents a distance between the wide-angle camera 3 and the driver's head 9 in the right-left direction (y direction), and “az” represents a distance between the wide-angle camera 3 and the driver's head 9 in the height direction.

“bx” is a distance between the wide-angle camera 3 and the rear seat occupant's head 19 in the front-rear direction, and “bz” is a distance between the wide-angle camera 3 and the rear seat occupant's head 19 in the height direction. “cx” is a distance between the wide-angle camera 3 and the steering wheel 11 in the front-rear direction, and “cz” is a distance between the wide-angle camera 3 and the steering wheel 11 in the height direction.

“dx” is a distance between the wide angle camera 3 and the foot 15 of the driver in the front-rear direction, and “dz” is a distance between the wide angle camera 3 and the foot 15 of the driver in the height direction. “ey” is a distance in the right-left direction (y direction) from the camera to the lower end of the front seat side window 23 and the lower end of the rear seat side window 25. “ez” is a distance in the z direction from the camera to the lower end of the front seat side window 23 and the lower end of the rear seat side window 25.

FIG. 5 is a diagram showing an example of camera disposition and an example of a determination result in the first embodiment. In FIG. 5, a, b, c, d, and e are arranged in the vertical direction, x, y, and z are arranged in the horizontal direction, and the value of each intersecting cell is the distance in each direction. “ax” to “ez” correspond to “ax” to “ez” in FIG. 4.

Note that “a” to “e” respectively correspond to the driver's head 9, the rear seat occupant's head 19, the steering wheel 11, the driver's foot 15, and the lower end of the front seat side window 23 (the rear seat side window 25), which are objects of interest.

The angle θ is an angle between a line connecting each of the objects of interest corresponding to “a” to “d” and the camera and the horizontal. In a case where the optical axis of the camera is in the vertically downward direction (z direction), an angle φ between the camera optical axis and each line connecting the camera and each object of interest corresponding to “a” to “d” is expressed by φ=90 degrees−θ.

The camera used in the first embodiment is, for example, a camera in which the number of pixels per 1 deg. rapidly increases when φ of the image height characteristic such as 3d in FIG. 3 is 45 degrees or more. Additionally, it is assumed that the image sensor is, for example, a 3M pixel image sensor. In this case, the number of pixels per 1 deg. of 45 degrees or more is 13 pix/deg. so that the image height characteristic of 3d in FIG. 3 is satisfied as a camera.

However, in the range of 0 to 45 degrees, the number of pixels per 1 deg. is 7 pix/deg. Additionally, in the whole, the average is 10 pix./deg., and in the case of a fisheye lens camera having one side of 90 degrees from the optical axis, 10×90=900 pix (one side) are set. Therefore, since 1800×2=900 pixels are set in one direction and 1800×1800 pixels are obtained, the angle characteristic of the number of pixels per 1 deg. can be realized by an image sensor with 3M pixels.

Next, the camera disposition of the present embodiment using this camera will be explained. In the present embodiment, as shown in FIG. 5, the camera is disposed such that the driver's head 9, the rear seat occupant's head 19, the steering wheel 11, the driver's foot 15, and the like, which are objects of interest, are within a range of the angle of view of 45 degrees to 90 degrees on one side from the optical axis of the camera.

Additionally, since the position of the accelerator and the brake is the most interesting position, the distance of the position of the driver's foot 15 from the wide-angle camera 3 in the y direction is the same as “ay”, which is the position of the center line of the body.

Additionally, since the position at which the angle φ is the smallest in the window is the lowermost end of the window of the portion at which the distance from the camera in the x direction is 0, the result is as indicated by e in the table of FIG. 5, and this can also satisfy the range of 45 to 90 degrees on one side from the optical axis of the camera. Thus, the camera can be disposed so as to satisfy the region of interest, and the region of interest during the travel and the region of interest while stopped can be imaged with high resolution.

### Comparative Example 1

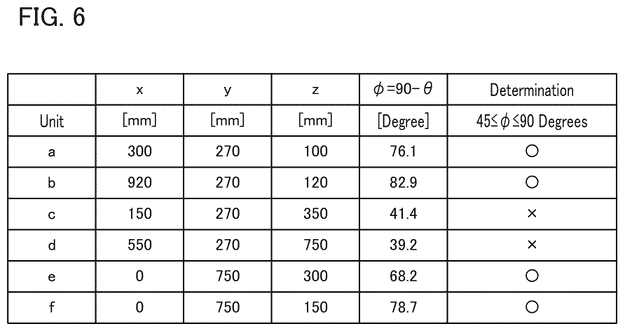

Next, a comparison to a camera system according to an example of disposition that is different from the first embodiment of the present invention will be explained with reference to FIG. 6. FIG. 6 is a diagram illustrating an example of the camera disposition and an example of the determination result in Comparative Example 1 that is different from the first embodiment. The camera is the same as that used in the first embodiment, and only the disposition of the camera is different.

In the disposition in FIG. 6, the position of the camera is disposed 20 cm in front of the vehicle in the x direction, compared to the disposition as shown in FIG. 5. Note that, as for the camera, because it is taken into consideration that there is no problem in terms of crime prevention if more than half of the lower end of the window is visible, the upper end is represented by f in the table, and the case where the height of “ez” is half is represented by “fz”.

In the disposition in FIG. 6, since the hand or the foot does not enter the angle of 45 to 90 degrees on one side from the optical axis of the camera, which is a high-resolution region, it is not possible to capture an image of the portion of the object of interest at a high resolution suitable for the purpose. Additionally, in a case where the camera is disposed 10 cm at the rear of the vehicle compared to the first embodiment, the camera is disposed completely beside the driver, so that the facial expression of the driver cannot be seen completely, the camera cannot function as a driver monitoring system, and the region of interest cannot be observed.

### Comparative Example 2

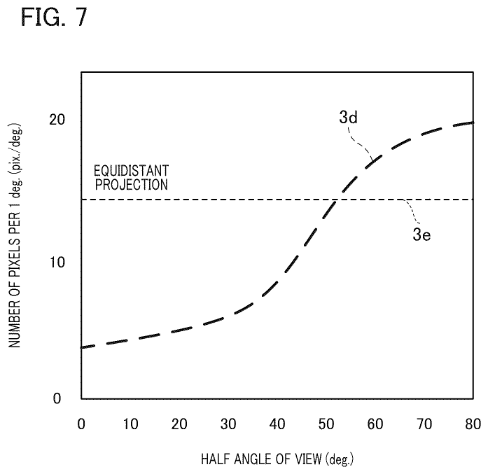

Next, a comparison to a camera system having an image height characteristic that is different from that of the first embodiment of the present invention will be explained with reference to FIG. 7. FIG. 7 is a diagram illustrating an example of Comparative Example 2 in which image height characteristic is different from those of the first embodiment. The position of the camera in this comparative example is substantially the same as that in the first embodiment, and only the image height characteristics of the camera are different.

In FIG. 7, the line of 3d represents the image height characteristics in the first embodiment, and the line of 3e represents the image height characteristics of Comparative Example 2. In the case of the image height characteristic indicated by 3e, the number of pixels per 1 deg. is 13 pix/deg. even at 45 degrees or more.

However, since a lens in which the projection characteristic of the fish-eye lens is equidistant projection is used, 13 pix./deg. is obtained even at 0 to 45 degrees on one side from the optical axis of the camera, and the number of pixels of the image sensor per side is 13×2×90=2340. Therefore, 2340×2340=about 5M pixels are required, an image sensor with 5M pixels that is more expensive than the image sensor with the 3M pixels in the first embodiment is required.

### Second Embodiment

Next, a camera system having a control unit (CPU and the like) for obtaining a score of a region of interest according to the second embodiment of the present invention will be explained. In the second embodiment, the control unit (CPU and the like) can score, as the score of the region of interest, the specific position of the region of interest to what extent the position is included in the range of φ/2 to φ of the angle φ, which is the target viewing angle.

Alternatively, the control unit scores a ratio of to what degree the region of interest falls within a region of φ/2 to φ with respect to the angle φ that serves as a target viewing angle. That is, a score indicating to what degree the region of interest specified in advance is included in the range of φ/2 to φ in a state where the wide-angle camera is installed is calculated by the control unit (CPU and the like). Additionally, how much area is occupied may be scored. Note that the control unit is controlled by executing a computer program by a computer.

In the second embodiment, the score calculated based on the angle is displayed as a numerical value in real time. Additionally, the captured image and scores for a plurality of portions in the image are displayed. When the score is high, it is possible to suitably perform observation for safe traveling while driving or for crime prevention while stopped.

The positions can be specified by learning and identifying a head of the occupant and a mirror by image recognition, and calculating the areas based on the semantic segmentations. Alternatively, when the position of the camera is adjusted, a pattern for facilitating recognition and identification, such as a AR marker, may be attached to an object of interest (region of interest) and recognized.

Then, when the position of the camera is adjusted, the angle value of the location of each object of interest (region of interest) and the pass/fail are displayed on the tablet terminal at hand, as shown in FIG. 5, and as a result, the mounting position and mounting angle of the camera can be adjusted while looking at the pass/fail terminal at hand.

The position of the camera may be manually adjusted, or may be automatically adjusted to a suitable disposition angle by searching for the maximum value of the score in conjunction with an automatic adjustment device. Specifically, the disposition work as described above is adjusted by a manual or automatic method so that the region of interest when the automobile is traveling and the region of interest when the automobile is stopped fall within the range of φ/2 to φ with respect to the angle φ, which is the viewing angle of the wide-angle camera.

### Third Embodiment

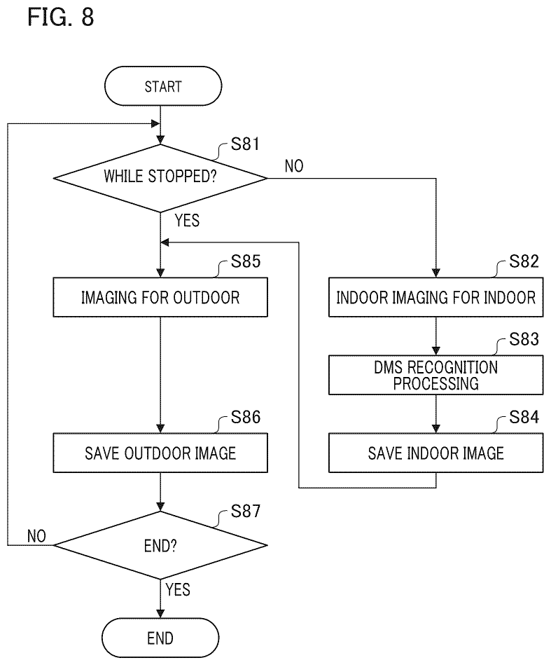

Next, FIG. 8 is a flowchart showing an example of the operation condition changing processing during the image capture in the third embodiment, and the operation of the camera system according to the first embodiment of the present invention will be explained with reference to FIG. 8. In the third embodiment, the operating conditions of the camera system can be changed.

That is, in the camera of the third embodiment, although the same region in the angle of view is used during the travel and while stopped, the camera can be more suitably used by switching the imaging condition between during the travel and while stopped.

The flowchart of FIG. 8 will be explained. Note that a camera CPU (not illustrated) serving as a computer provided in the wide-angle camera 3 executes a computer program stored in a memory (not illustrated), thereby sequentially performing the operation of each step in the flowchart of FIG. 8.

When the camera power supply is turned on, the processes of the flowchart of FIG. 8 start. In step S81, the camera CPU determines the traveling state, and determines whether or not the automobile is stopped (traveling). That is, when it is determined in step S81 that the vehicle is not stopped, it is determined that the vehicle is traveling, and in step S82, imaging is performed under the indoor imaging conditions.

Specifically, for example, imaging is performed by performing the accumulation time control of the image sensor so that the signal level of an image obtained from the driver's head 9, the rear seat occupant's head 19, the steering wheel 11, the driver's foot 15, and the like, which are objects of interest, is optimized. Note that white balance control for indoor use may be performed. Additionally, focus adjustment is performed so that, for example, the average value of the contrast of the indoor object of interest is maximized.

Next, in step S83, the camera CPU causes a driver monitoring system (DMS) to perform image recognition of an indoor object based on the image data captured in step S81 and detect an abnormality and the like (the driver is drowsy, the pulse is abnormal, and the like).

If a predetermined abnormality is detected, for example, a warning is displayed to the driver. In addition, in step S84, the indoor image and the recognition result in step S83 are stored in a storage media (not illustrated). Alternatively, they are stored in an external server and the like via communication to the outside. Then, the process proceeds to step S85.

In contrast, in a case where the determination in step S81 is YES, that is, if it is determined that the vehicle is stopped, the process proceeds to step S85, and outdoor image capturing is performed by the CPU in the camera. Specifically, the accumulation time control of the image sensor is performed such that the luminance level becomes optimum, based on the luminance level of the image outside the vehicle through the front window 21 and the rear window 27, which are the object of interest, among the outputs from the image sensor, and the image is captured.

Note that, in the outdoor image capturing, the accumulation time is set to be shorter than that in the indoor image capturing in step S82. Note that, at this time, white balance control may be performed according to an outdoor color temperature. Additionally, at this time, focus adjustment is performed so that, for example, the average value of the contrast an object of interest outdoors (outside the vehicle) is maximized.

Furthermore, in a case where an obstacle and the like are recognized by image recognition performed on the result of the outdoor imaging, the control of the traveling of the automobile (direction change and braking operation) may be performed so as to avoid the obstacle. Additionally, in a case where a suspicious person and the like outside the vehicle are recognized while the vehicle is stopped, information on the suspicious person may be displayed as a warning on a smartphone terminal and the like of the user.

Furthermore, in step S86, the camera CPU causes a storage media (not illustrated) to store an outdoor image and data related to the recognition result of the obstacle, suspicious individual, and the like recognized in step S85. Alternatively, the image and data are stored in an external server and the like via communication to the outside. Then, the process proceeds to step S87.

In step S87, the camera CUP determines whether or not an operation for ending the flow in FIG. 8 has been performed by the user, and if the determination is YES, the flow in FIG. 8 ends. If the determination is NO in step S87, the process returns to step S81, and the flow of FIG. 8 is periodically repeated in units of frames.

Note that, in the flow of FIG. 8, each of indoor images and outdoor images is stored. However, for example, in the case of NO in step S81, that is, during the travel, an image optimized to low illumination for indoor and an image optimized to high illumination for outdoor may be combined to generate an image with a wide dynamic range, and the image may be stored.

Specifically, in the third embodiment camera, an exposure or focus of the wide-angle camera is adjusted according to a region of interest outside the vehicle when the vehicle is stopped by a control unit (CPU), and the exposure or focus of the wide-angle camera is adjusted according to a region of interest inside the vehicle when the vehicle is traveling by the control unit (CPU).

According to the third embodiment, it is possible to simultaneously realize the face recognition serving as the driver monitoring function and the function serving as the front drive recorder with high resolutions during the travel by performing the control as shown in the flow of FIG. 8. Note that it is assumed that the indoor imaging in step S82 during the travel and the outdoor imaging in step S85 are switched, for example, in a predetermined frame unit.

Note that a specific region may be cut out, limited to the dynamic range of the specific region, reduced in size, and stored. Furthermore, for the face region, it is necessary to apply the image information to the recognition processing in order to acquire biological information such as sleepiness and inattention of the driver. Since the recognition processing is performed based on the image whose exposure and focus are optimized for indoors, the image recognition accuracy can be improved.

Additionally, in the case where the vehicle is stopped, in which the determination in step S81 is YES, exposure control and focus adjustment optimized for the brightness of the outdoors and a distance of an outdoor object is performed, so that the recognition accuracy of a suspicious person outside the vehicle can be improved.

Note that, while the vehicle is stopped, short-time video processing and determination such as avoidance of collision with an obstacle are not required as an imaging condition, as compared to the case where the vehicle is traveling outdoors. Therefore, the frame rate may be decreased to reduce the amount of data to be stored. Although, in the above explanation, the imaging conditions suitable for each of the traveling and stopping states have been explained, the imaging conditions to be switched between the traveling and stopping states are not limited to the examples as described above.

### Fourth Embodiment

Next, a camera system according to the fourth embodiment of the present invention will be explained. In the camera system according to the fourth embodiment, while the vehicle is stopped, imaging is performed only when a proximity sensor using an infrared sensor and the like detects a moving object, instead of performing imaging at a constant cycle.

That is, the main purpose of imaging while stopped is crime prevention, and the object of interest is a suspicious person and the like approaching the vehicle. Hence, in a case where the moving object outside the vehicle does not approach the vehicle, it is not necessary to store the captured image.

Therefore, in the fourth embodiment, in a case where it is determined in step S81 that the vehicle is stopped and an object approaching the vehicle is detected by the proximity sensor, imaging is performed in conjunction with the detection, and the captured image and the image recognition result are stored, in consideration of the capacity of the storage unit for storing images and the like. That is, while the vehicle is stopped, imaging is performed based on the output of the other proximity sensors. Thus, a suitable crime prevention system can be provided.

### Fifth Embodiment

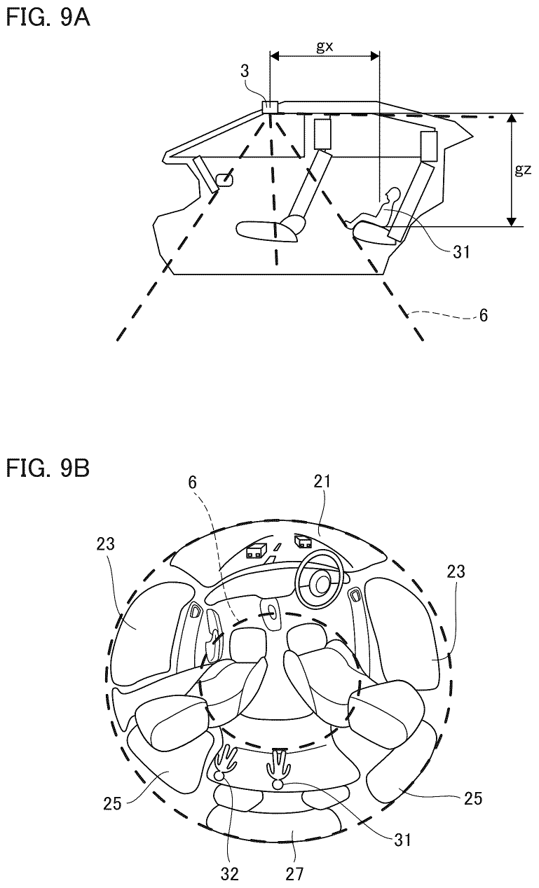

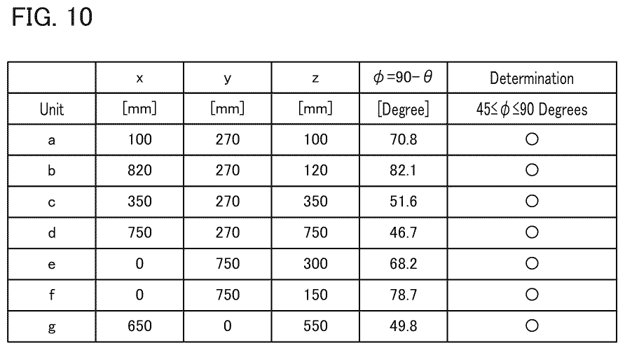

Next, a camera system according to the fifth embodiment of the present invention will be explained with reference to FIG. 9 and FIG. 10. FIGS. 9A and 9B are diagrams for explaining an example of a region of interest in the camera system according to the fifth embodiment. FIG. 10 is a diagram illustrating an example of a relation between a camera and an object of interest according to the fifth embodiment.

The fifth embodiment is different from the first embodiment on the point that a function of preventing an infant from being left unattended in the vehicle is provided by setting a rear seat while stopped as a region of interest. That is, in the fifth embodiment, the region of interest in the vehicle when the vehicle is stopped includes the rear seat. FIG. 9A is a longitudinal sectional view of an automobile, and FIG. 9B shows an image captured by a camera.

In the drawing, reference numeral 31 denotes a child left at the center of the rear seat, and reference numeral 32 denotes a child left at the end portion of the rear seat. Additionally, “gx” is a distance in the x direction from the wide angle camera 3 to the child 31 left at the center of the rear seat, and “gz” is a distance in the height direction from the wide angle camera 3 to the child 31 left at the center of the rear seat.

Other symbols are the same as those in FIG. 1. In the fifth embodiment, as a function while stopped, a function of preventing someone from being left unattended in the vehicle is provided in addition to a crime prevention function of monitoring the outside of the vehicle. For example, if a sleeping child or the like is left in the rear seat, the temperature in the interior of the vehicle rises and dehydration occurs, which may lead to a death accident.

For the purpose of avoiding such a situation, a function of detecting the leaving of an infant and the like unattended in the vehicle is provided. That is, in the fifth embodiment, a region in which there is a possibility that an infant who is left unattended on the rear seat may be present is considered as a region of interest.

Therefore, it is assumed that the position of the camera further has a relation of “gx” and “gz” with the camera as shown in FIG. 10 while satisfying the relation with other regions of interest. Accordingly, the child 31 who has been left at the center of the rear seat can be sufficiently imaged in a high-resolution region in a range of 45 to 90 degrees on one side from the optical axis of the camera.

Note that FIG. 9B is a diagram showing an example of the positional relation of the object of interest imaged through the lens, and a child 33 left unattended at the end portion of the rear seat can be imaged in the high-resolution region, in addition to the child 31 who is left at the center of the rear seat.

Additionally, as a function of detecting that an infant and the like are left in the vehicle while stopped, images are captured by periodically (for example, about one frame per second) adjusting exposure conditions and focus to the inside of the vehicle (indoor) and carrying out the left-behind detection determination by image recognition while performing a crime prevention of the outside of the vehicle, which is conventional purpose. Thus, both the purpose of crime prevention and the purpose of detecting that someone is left unattended in the vehicle can be achieved.

Additionally, the presence or absence of someone left unattended in the vehicle may be determined with the naked eye when an inquiry is received from a user's mobile terminal and the like, in addition to the image recognition. For this purpose, when there is an inquiry from the user, imaging may be performed by adjusting the exposure condition and the focus to the interior of the vehicle for a predetermined time, and the image obtained thereby may be transferred to the mobile terminal of the user and displayed. As a result, the presence or absence of someone left unattended in the vehicle can be confirmed even from a remote location.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the camera system and the like through a network or various storage media. Then, a computer (or a CPU, an MPU, and the like) of the camera system and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2023-125693, filed on Aug. 1, 2023, which is hereby incorporated by reference herein in its entirety.

What is claimed is:

1. A camera system comprising:
a wide-angle camera disposed in an interior of a vehicle,
wherein the wide-angle camera is disposed between a driver's seat and a rear seat so that an optical axis is directed downward, and a region of interest during travel of the vehicle and a region of interest while the vehicle is stopped are disposed so as to fall within a range of φ/2 to φ with respect to an angle φ, which is a viewing angle of the wide-angle camera.

2. The camera system according to claim 1, wherein the wide-angle camera is a fisheye lens camera.

3. The camera system according to claim 1, wherein the region of interest during the travel includes the head of a person in the interior of a vehicle, and the region of interest while stopped includes outside a window of the vehicle.

4. The camera system according to claim 1, wherein a resolution in the range φ/2 to φ is higher than a resolution in a range outside φ/2 to φ.

5. The camera system according to claim 1, further comprising one or more memories storing instructions; and one or more processors executing the instructions to calculate a score indicating to what degree the region of interest specified in advance is included in the range φ/2 to φ, in a state where the wide-angle camera is installed.

6. The camera system according to claim 1, further comprising one or more memories storing instructions; and one or more processors executing the instructions to adjust an exposure or focus of the wide-angle camera according to a region of interest outside the vehicle while stopped and adjust an exposure or focus of the wide-angle camera according to a region of interest in the vehicle during the travel.

7. The camera system according to claim 1, wherein, imaging is performed while stopped, based on an output of another proximity detecting sensor.

8. The camera system according to claim 1, wherein a region of interest during the travel includes a driver's foot.

9. The camera system according to claim 1, wherein a region of interest in a vehicle while stopped includes a rear seat.

10. An installation method of a wide-angle camera disposed in an interior of a vehicle,
wherein the wide-angle camera is disposed between a driver's seat and a rear seat so that an optical axis is directed downward, and
wherein a region of interest during travel of the vehicle and a region of interest while stopped of the vehicle fall within a range of φ/2 to φ with respect to an angle φ, which is a viewing angle of the wide-angle camera, and a resolution in the range φ/2 to φ is higher than a resolution in a range outside of φ/2 to φ.

11. A non-transitory computer-readable storage medium configured to store a computer program to control a camera system configured to have a wide-angle camera disposed in an interior of a vehicle, wherein the wide-angle camera is disposed between a driver's seat and a rear seat so that an optical axis is directed downward, and a region of interest during travel of the vehicle and a region of interest of the vehicle while stopped fall within a range of φ/2 to φ with respect to an angle φ, which is a viewing angle of the wide-angle camera,
wherein the computer program comprises instructions for executing following process:
adjusting an exposure or focus of the wide-angle camera according to a region of interest outside the vehicle while stopped and adjusting an exposure or focus of the wide-angle camera according to a region of interest in the vehicle during the travel.
